(19) United States
(12) Patent Application Publication
(10) Pub. No.: US 2021/0066839 A1
(43) Pub. Date: Mar. 4, 2021

(54) INTERFACE FOR CONNECTING AN ELECTRIC MOTOR TO A WIRING HARNESS, AND ELECTRIC MOTOR

(71) Applicant: U-SHIN DEUTSCHLAND ZUGANGSSYSTEME GMBH, Erdweg (DE)

(72) Inventors: Frank KUMMER, Erdweg (DE); Eiji HIRAO, Erdweg (DE); Toshiyuki YAHARI, Erdweg (DE)

(21) Appl. No.: 16/760,064

(22) PCT Filed: Oct. 19, 2018
(86) PCT No.: PCT/EP2018/078771

§ 371 Date: Apr. 29, 2020

(30) Foreign Application Priority Data
Oct. 30, 2017 (DE) 10 2017 125 410.2

(51) Int. Cl. H01R 13/432; H02K 5/14

(52) U.S. Cl. CPC H01R 13/432; H01R 2201/10; H02K 5/14

(57) ABSTRACT

An interface connects an electric motor to a wiring harness, with a motor-side housing, in which two plugging chambers are provided, wherein a contact blade of the electric motor extends into each plugging chamber, wherein each plugging chamber is provided with a stop for a plugging sleeve and a latching element for the plugging sleeve. The invention also relates to an electric motor with such an interface.

The invention relates to an interface for connecting an electric motor to a wiring harness and to an electric motor with such an interface.

In many application cases it is usual for the wires via which the electrical energy for driving the electric motor is provided, to be soldered to the corresponding terminals of the electric motor. Although this is advantageous with regard to contacting reliability (in any case if the solder joint is made according to the specifications), soldering is associated with high efforts.

It is also known that the wires are provided with plug contacts which are pushed onto the electrical terminals of the electric motor. However, this is not optimal with regard to contacting reliability.

The object of the invention is to connect an electric motor reliably to a wiring harness without high efforts being necessary.

To achieve this object, the invention provides an interface for connecting an electric motor to a wiring harness, with a motor-side housing in which two plugging chambers are provided, wherein a contact blade of the electric motor extends into each plugging chamber, wherein each plugging chamber is provided with a stop for a plugging sleeve and a latching element for the plugging sleeve. To achieve this object, there is also provided an electric motor with such an interface. The invention is based on the basic idea of integrating a mechanical latching device into the electric motor, which guarantees a mechanical locking both when plugged in and against unintentional release. This results in a high level of contacting reliability while at the same time the plugging sleeve can be attached in the usual manner, namely can be pushed onto the contact blade of the electric motor.

According to a preferred embodiment of the invention, the stop and the latching element are formed by opposite end faces of a narrowing of the plugging chamber. The two elements can thus be formed compact on one and the same component, namely on the narrowing.

The narrowing is preferably arranged approximately at the height of the free end of the contact blade. This guarantees that the plugging sleeve must be pushed far enough onto the contact blade of the electric motor before a catch spring provided on the plugging sleeve latches behind the narrowing.

The plugging chamber preferably has a lead-in chamfer for the plugging sleeve, with the result that the plugging sleeve is reliably guided into the plugging chamber.

The housing in which the plugging chambers are integrated is preferably a brush holder housing of the electric motor, with the result that no additional components are necessary.

The brush holder housing can receive a printed circuit board, on which a motor sensor is arranged. RPM and/or angular position signals can be detected with the motor sensor. Due to the integration in the brush holder housing, the corresponding sensor can be arranged at a suitable point with little outlay.

The printed circuit board preferably has an opening which is arranged concentric to the motor shaft. It is thus possible to support the motor shaft mechanically if, for example, a pinion is pressed onto the motor shaft on the opposite side.

The printed circuit board can be secured to the housing by at least one plastically deformed locking pin. Such a locking pin can be suitably reshaped, for example after having been heated, with the result that it reliably holds the printed circuit board in the manner of a rivet, without there being the risk that the connection between printed circuit board and housing will loosen in the event of vibrations.

A plug-in connector for connecting the motor sensor is preferably provided on the printed circuit board. This makes it easier to connect the electric motor to the wiring harness completely.

The plugging chambers preferably extend in the axial direction. The contacting of the contact blade of the electric motor is thereby made easier as the back of the electric motor is usually comparatively easy to access.

According to an embodiment of the invention, the housing is provided with a torque support with which a torque of the electric motor can be supported. The torque support prevents the electric motor from twisting in the receiver provided for it when a particularly high torque is acting. If the electric motor were to twist, this could lead to the wires of the wiring harness or the plug-in connection between the wires and the electric motor being damaged.

The invention is described below with reference to an embodiment, which is represented in the attached drawings. There are shown in:

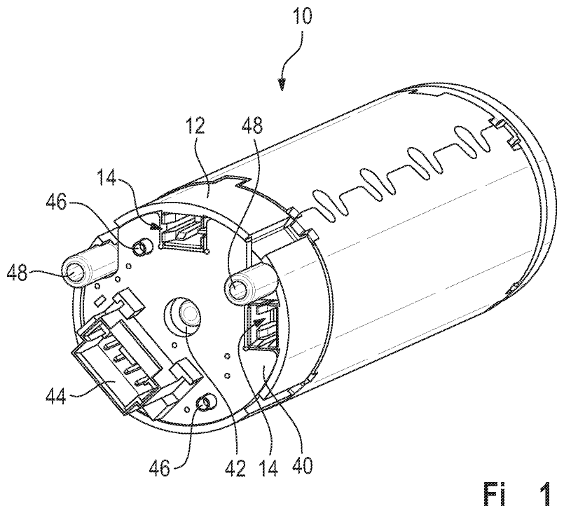

FIG. 1, in a perspective view, an embodiment of an interface according to the invention;

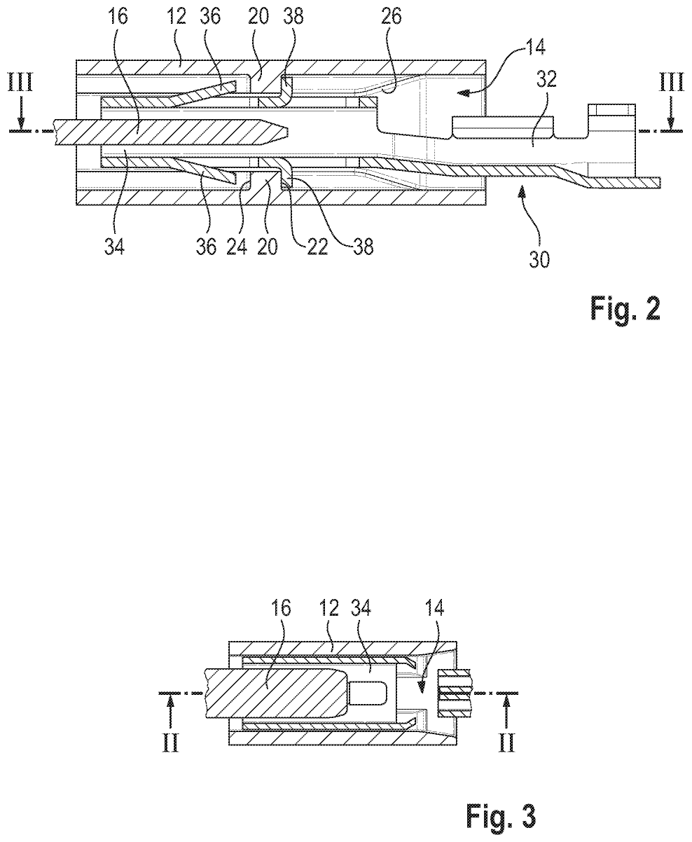

FIG. 2 a plugging chamber used in the interface in a first sectional view; and

FIG. 3 the plugging chamber from FIG. 2 in a second sectional view.

An electric motor 10 can be seen in FIG. 1, which is provided in particular to be used in actuators such as are used in motor vehicles. One example is a spindle drive.

On its side facing away from the output side, the electric motor is provided with an interface which serves to connect it to a wiring harness. The interface serves both to transmit the electrical energy for driving the electric motor 10 and to connect the electric motor 10 to a control.

The interface has a housing 12 which is designed here as a brush holder housing. Two plugging chambers (see also FIGS. 2 and 3) are integrated in the housing 12, which are arranged such that a contact blade 16 of the electric motor extends into each plugging chamber 14. The two contact blades 16 serve to transmit the electrical drive power to the electric motor 10.

Each plugging chamber 14 is provided with a narrowing 20, which has a shoulder on opposite sides in each case. The shoulder arranged on the outside of the plugging chambers 14 represents a stop 22, and the shoulder arranged on the inside of the plugging chambers 14 represents a latching element 24.

As can be seen in FIG. 2, the narrowing, viewed in the axial direction of the contact blade 16, lies approximately at the height of the free end of the contact blade.

Each plugging chamber 14 is moreover provided with lead-in chamfers 26, which guide a plug-in connector into the correct position when it is being plugged into the plugging chamber 14.

For the contacting of the contact blades 16, plugging sleeves 30 are used, which in each case have a terminal end 32 which serves to connect the cores of a wire. The wire can be crimped for example to the plugging sleeves.

Each plugging sleeve 30 furthermore has a contact section 34 which serves to contact the corresponding contact blade 16.

In the region of the contact section 34, the plugging sleeve 30 has two latching tabs 36 which serve to latch behind the latching elements 24 of the constriction 20 when the plugging sleeve is completely plugged in.

Finally, each plugging sleeve 30 has two stop tabs 38 which can rest against the stop 22 of the constriction 20 when the plugging sleeve 30 is pushed onto the corresponding contact blade 16.

Both the catch springs 36 and the stop tabs 38 are bent out of the material of the plugging sleeve 30 by suitably die-cutting and then deforming a single-piece sheet metal blank.

The catch springs 36 together with the stop tabs 38 guarantee that the plugging sleeve 30, if it is pushed far enough onto the corresponding contact blade 16, locks mechanically inside the plugging chamber 14, but also cannot be pushed on too far.

The brush holder housing 12 moreover serves to receive a printed circuit board 40 which carries a motor sensor for detecting the RPM and/or the angular position of the rotor of the electric motor. The motor sensor cannot be seen here as it is arranged on the side of the printed circuit board 40 facing the electric motor.

The printed circuit board 40 almost completely covers the back of the brush holder housing 12, as can be seen in FIG. 1. Only the access to the plugging chambers 14 remains free, as well as a central opening 42, which is concentric to the motor shaft. The motor shaft can be supported by the opening 42, in order to be able for example to press a pinion onto the output side.

The printed circuit board 40 bears a plug-in connector 44 into which a complementary plug-in connector can be plugged in order to connect the motor sensor electrically to a control.

The printed circuit board 40 is mechanically secured to the brush holder housing 12 in that two locking pins 46, which are made in one piece with the brush holder housing 12, extend through corresponding holes in the printed circuit board 40 and are plastically deformed on the outside, for example by hot forming.

The brush holder housing 12 moreover has a torque support 48 which is formed here in the form of two pins extending in the axial direction. The pins can engage in complementary openings of a module housing or another receiver for the electric motor 10, with the result that the motor housing cannot twist in the circumferential direction. The connection wires of the electric motor are hereby prevented from being damaged by the electric motor rotating about its own axis when a particularly high reaction torque is acting on it.

As the plugging chambers 14 are aligned in the axial direction, the plugging sleeves 30 are also pushed on in the axial direction. This is advantageous in terms of assembly. Moreover, when the plugging sleeves 30 are plugged in, there is a haptic feedback when the catch springs 36 latch behind the narrowing 20. The catch springs 36 guarantee that the plugging sleeve 30 reliably remains on the contact blade 16. In order to remove the plugging sleeve 30, the catch springs 36 must be bent so much that the plugging sleeve is unusable.

1. An interface for connecting an electric motor to a wiring harness, wherein the interface comprises a motor-side housing, in which two plugging chambers are provided, wherein a contact blade of the electric motor extends into each plugging chamber, wherein each plugging chamber is provided with a stop for a plugging sleeve and a latching element for the plugging sleeve.

2. The interface according to claim 1, characterized in that the stop and the latching element are formed by opposite end faces of a narrowing of the plugging chamber.

3. The interface according to claim 2, characterized in that the narrowing is arranged approximately at the height of the free end of the contact blade.

4. The interface according to claim 1, characterized in that the plugging chamber has a lead-in chamfer for the plugging sleeve.

5. An electric motor with an interface according to claim 1.

6. The electric motor according to claim 5, characterized in that the housing is a brush holder housing of the electric motor.

7. The electric motor according to claim 6, characterized in that the brush holder housing receives a printed circuit board on which a motor sensor is arranged.

8. The electric motor according to claim 7, characterized in that the printed circuit board has an opening which is arranged concentric to the motor shaft.

9. The electric motor according to claim 7, characterized in that the printed circuit board is secured to the housing by at least one plastically deformed locking pin.

10. The electric motor according to claim 7, characterized in that a plug-in connector for connecting the motor sensor is provided on the printed circuit board.

11. The electric motor according to claim 5, characterized in that the plugging chambers extend in the axial direction.

12. The electric motor according to claim 5, characterized in that the housing is provided with a torque support with which a torque of the electric motor can be supported.
